(19) United States
(12) Patent Application Publication
(10) Pub. No.: US 2025/0350048 A1
(43) Pub. Date: Nov. 13, 2025

(54) ELECTRICAL LINE CONNECTION FOR ELECTRICAL CONTACTING

(71) Applicants: SAINT-GOBAIN GLASS FRANCE, COURBEVOIE (FR); FEW Fahrzeugelektrik Werk GmbH & Co. KG, ZWENKAU (DE)

(72) Inventors: Francois HERMANGE, HERZOGENRATH (DE); Bernhard REUL, HERZOGENRATH (DE); Volker LAMMERTS, ZWENKAU (DE); Peter Thomas KRABS, ZWENKAU (DE)

(21) Appl. No.: 18/880,111

(22) PCT Filed: Jun. 28, 2023
(86) PCT No.: PCT/EP2023/067646

§ 371 Date: Dec. 30, 2024

(30) Foreign Application Priority Data
Jul. 12, 2022 (EP) 22184438.4

(51) Int. Cl. H01R 12/63; H01R 4/02; H01R 4/70

(52) U.S. Cl. CPC H01R 12/63; H01R 4/021; H01R 4/70; H01R 2201/26

(57) ABSTRACT

An electrical line connection having a cross-sectional transition region from a flat ribbon cable to a cable, in particular a round cable, wherein, in the cross-sectional transition region, an electrical connection between the conductor track of the flat ribbon cable and the conductor of the cable is provided, wherein the cross-sectional transition region has an encapsulation for electrical insulation, wherein a first sealing device is provided on the flat ribbon cable and a second sealing means is provided on the cable, wherein the first sealing device is a double-sided adhesive tape which is arranged on two opposite surfaces of the flat ribbon cable and wherein the second sealing device has one, two or more sealing lips.

The invention relates to an electrical line connection having a cross-sectional transition region, and a substrate comprising a functional element, and a composite pane comprising at least one such line connection.

In the case of composite panes having at least two rigid panes and one intermediate layer connecting said panes in a planar manner, as well as electrical components, such line connections usually comprise a transition from a flat ribbon cable to a cable. The components installed in a composite pane can be heating components, antenna elements, and flat-mounted functional elements which can be electrically contacted via what are known as busbars. Composite panes equipped in this way are used as glazing units in automobiles as a windshield, rear pane, and side pane, or also in the construction sector.

Functional elements having electrically controllable optical properties are used in the industrial production of composite panes, e.g., as roof panes. The functional element is embedded in the composite pane. During the manufacture of the composite pane, the functional element is cut to the desired size and shape from a multilayer film and embedded between the films of an intermediate layer. Typical intermediate layers are polyvinyl butyral films which, in addition to their adhesive properties, have high toughness and high acoustic damping. The intermediate layer prevents the disintegration of the composite pane when damaged. The composite pane only becomes cracked, but remains dimensionally stable.

Such composite panes contain a functional element which typically contains an active layer between two surface electrodes. The optical properties of the active layer can be changed by a voltage applied to the surface electrodes. An example of this is electrochromic functional elements. Another example is SPD functional elements (Suspended Particle Device) or PDLC functional elements (Polymer Dispersed Liquid Crystal). By applying voltage to the flat electrodes, the transmission of visible light can be controlled by electrochromic SPD/PDLC functional elements.

SPD and PDLC functional elements are commercially available as multilayer films. The surface electrodes required for applying a voltage are arranged between two PET carrier films. The surface electrodes can be electrically conductively connected outside the composite pane to a control module (ECU) by means of flat ribbon conductors. The control module is provided for applying an electrical voltage between the surface electrodes.

In order to guide a flexible line connection as an outer connection out of the interior of the composite pane, flat lines are usually used, which consist of at least one thin carrier substrate and at least one metal conductor track (conductor strip). In addition, a cover layer can be provided so that the flat ribbon conductor overall forms a three-layer laminate. The flat ribbon conductors are soldered to connection surfaces close to the edge of the composite pane and guided away outwards only over this edge, where they are connected to a round cable at a distance from the edge. The connection point of the two lines is embedded in an encapsulation made of insulating material. Since it is not possible to prevent moisture from penetrating into the encapsulation, interference can arise at the junction due to sealing failure.

EP 1 058 349 A1 discloses a structure for connecting an electrical cable to a flat cable. Both the cable and the flat cable each comprise a resilient sealing material at its end portion. When the two cables are overmolded in the region of the connection portion, the resilient sealing materials adhere to the outer surface of the respective cable by compression.

GB 2 539 834 A describes an electrical connection which electrically connects a flat cable and a cable, the electrical connection comprising a first seal, an optional second seal and a sheath. The sheath encloses at least the first seal and the electrical contact.

WO 2013/178727 A1 relates to an electrical plug connector comprising an electrical cable surrounded by an insulating sheath, and a housing arranged on a portion of the electrical cable. A seal arranged on the electrical cable sealingly surrounds the insulating sheath.

The object of the present invention is to provide an improved electrical line connection which ensures a secure and permanently watertight seal at the cross-sectional transition.

The object of the present invention is achieved according to the invention by an electrical line connection according to independent claim 1. Preferred embodiments of the invention emerge from the dependent claims.

The invention comprises an electrical line connection having a cross-sectional transition region from a flat ribbon cable to a cable, in particular a round cable, the flat ribbon cable comprising at least one electrical conductor track and a cover film for electrically insulating the conductor track. Furthermore, the cable comprises an electrical conductor. An electrical connection between the conductor track of the flat ribbon cable and the conductor of the cable is provided in the cross-sectional transition region. The cross-sectional transition region has an encapsulation for electrical insulation. A first sealing means is provided on the flat ribbon cable and a second sealing means is provided on the cable. When the encapsulation is attached to the line connection, the first sealing means is firmly pressed against the flat ribbon cable and the second sealing means is firmly pressed against the cable, in particular round cable, so that a seal is produced around the respective cable. Such an arrangement of the sealing means (seals) ensures that the penetration of water into the encapsulation, by a capillary effect, is prevented.

According to the invention, the first sealing means is a double-sided adhesive tape, which is arranged on two opposite surfaces of the flat ribbon cable, it being possible for the first sealing means to be provided particularly preferably around the flat ribbon cable. The adhesion by the adhesive tape advantageously supports the adhesion of the encapsulation to the flat ribbon cable so that the connection between the encapsulation and the flat ribbon cable is very tight and stable. In particular, the adhesive tape may be an acrylic adhesive tape. In addition, the adhesive tape may be transparent. The material thickness of the adhesive tape can have a thickness of 25 μm to 2 mm, preferably 100 μm to 150 μm, particularly preferably 130 μm [micrometers].

The encapsulation can cover the first sealing means and the second sealing means completely or only in part. Complete enclosure of the sealing means effectively closes the passage for particles and water and penetration thereof into the encapsulation in order to prevent damage to the line connection.

The second sealing means can have a ring shape, the second sealing means surrounding the cable, in particular as a round cable, in a flush manner, i.e., the second sealing means is provided all around the cable. In this case, the second sealing means can be fastened and molded to the cable during production. The second sealing means may be mounted on the cable prior to manufacturing the encapsulation. The second sealing means can be designed as a collar portion on the cable.

The second sealing means has one, two or more sealing lips. The circumferential sealing lips extend at a radially outwardly facing portion of the second sealing means. As a result of the one and more sealing lips, a higher water resistance of the electrical line connection can be achieved. The two or more sealing lips can be arranged one behind the other in the direction of extension of the cable and be at a distance from one another. The two or more sealing lips can have outer edges extending in parallel with one another. In addition, the second sealing means can have a wave-shaped surface, in portions, on its surface facing the cable. The second sealing means may contain silicone, polyvinyl chloride or thermoplastic elastomers.

In a further embodiment of the electrical line connection according to the invention, the conductor track of the flat ribbon cable can be electrically-conductively connected to the conductor of the cable via a solder connection. Alternatively, the electrical connection can be produced by an adhesive connection by means of an electrically-conductive adhesive. The electrically-conductive adhesive contains at least one electrically-conductive material—preferably metallic material—for example, silver, gold, or aluminum. It is also possible for the electrically-conductive adhesive to contain a non-metal electrical material—for example, graphite or carbon. The at least one electrically-conductive material is introduced into a non-electrically-conductive adhesive matrix—for example, epoxy resin. The at least one electrically-conductive material is contained in the adhesive in such an amount that a desired current load capacity is achieved. Preferably, the at least one electrically-conductive material is contained in the adhesive at a mass fraction of at least 70%.

The flat ribbon cable comprises at least one electrical conductor track applied to the first cover film as a carrier substrate made of plastics material, which track can also be covered with the first cover film. The cover film forms an insulation sheath which surrounds the electrical conductor track. The cover film preferably contains polyimide (PI) or polyester, particularly preferably polyethylene terephthalate (PET) or polyethylene naphthalate (PEN), or consists thereof. The cover film can also consist of an electrically-insulating lacquer, preferably a polymer lacquer. The cover film can also contain or consist of thermoplastic materials and elastomers such as polyamide, polyoxymethylene, polybutylene terephthalate, or ethylene propylene diene rubber. Alternatively, casting materials such as acrylate or epoxy resin systems can be used as the cover films. Such cover films are cost-effective and simplify the production process.

The in particular flexible and/or resilient flat ribbon cable serves for electrical connection to an electrical component or a surface electrode. The flat ribbon cable is a two-dimensional body having two opposite sides, which can optionally be brought into a planar or curved shape. In the planar (i.e., non-curved) state, the flat ribbon cable is arranged in one plane. The flat ribbon cable is generally elongate and has two ends along its extension direction. The flat ribbon cable can also be provided with a plurality of—in particular, parallel running—electrical conductor tracks. Preferably, the flat ribbon cable can have up to 32, particularly preferably 8 to 10, conductor tracks. The conductor tracks are arranged in a common plane. Each conductor track can have a rectangular cross section. The flat ribbon cable is an elongated electrical component having several electrical conductor tracks, the width of which is significantly greater than the thickness. The flat ribbon cable is formed to be thin enough (i.e., the thickness is small enough) that it is flexible and pliable. Its width can be 0.1 mm to 100 mm.

Furthermore, the flat ribbon cable comprises at least two connection regions with contact points of the conductor tracks on two opposite, in the extension direction, ends of the flat ribbon cable. The two connection regions of the flat ribbon cable serve for electrically contacting the conductor tracks, for which purpose the cover film, i.e., the carrier layer and/or insulation layer, is not present or removed, at least at the contact points, so that the conductor tracks are accessible.

The electrical conductor tracks can be arranged next to one another and/or lying one above the other, at least in portions. In a further advantageous embodiment of the invention, at least two electrical conductor tracks are arranged one above the other in at least two, and preferably in exactly two or exactly three or exactly four, planes. Here, “one above the other means” with respect to the extension plane of the flat ribbon cable, i.e., with respect to the plane spanned by the two larger dimensions of the flat ribbon cable. Advantageously, at least two conductor tracks are in each case arranged congruently in the projection orthogonally to the extension plane. Alternatively, the conductor track can also be designed to be larger in one plane and can substantially take up the plane within the flat ribbon cable partially or completely—preferably minus an insulating edge region. This increases the current load capacity of this conductor track.

Each electrical conductor track can be electrically contacted at two contact points spaced apart from one another along the conductor track. The contact points are regions of the conductor tracks where an electrical contact is possible. In the simplest embodiment, these are accessible regions of the electrical conductor tracks. It may be necessary and expedient here to provide a separate line connection for each pole so that in each case one conductor track of the flat ribbon cable is provided for connection to a conductor of a cable.

The conductor tracks are applied by means of printing. Alternatively, the electrical conductor tracks are prefabricated as metal strips made of metal foil and are laminated on both sides with a plastics material. In both cases, the electrical conductor tracks are mechanically stabilized and embedded in an insulation sheath made of a cover film so that they are electrically insulated against the external environment.

The metal foil can contain or consists of a copper foil, an aluminum foil, a stainless steel foil, a tin foil, a gold foil, or a silver foil. The metal foil can also contain or consist of alloys with the metals mentioned. The metal foil can advantageously be tin-plated in part or completely. This is particularly advantageous for achieving good solderability while at the same time providing corrosion protection.

In an advantageous embodiment of the flat ribbon cable according to the invention, the at least one conductor track has a thickness of 35 μm to 100 μm, and preferably 50 μm to 70 μm. The conductor track or the plurality of conductor tracks each contain a thin copper, silver, tin or gold film, for example.

The films can additionally be plated for example, silver-plated, gold-plated, or tin-plated. The thickness of the films is, for example, 35 μm, 50 μm, 75 μm, or 100 μm. According to one embodiment, the electrical conductor tracks have a width of 0.05 mm to 40 mm, preferably 1 mm to 22 mm, and in particular 2 mm to 5 mm. Such widths are particularly suitable for achieving sufficient current load capacity in conjunction with the above-mentioned thicknesses.

Such flexible flat ribbon cables have a connection region (contact points) at their two ends, which has at least one recess of the cover film.

In a further preferred embodiment of the electrical line connection according to the invention, the encapsulation has a plastics material as the insulating material. The encapsulation can consist of a correspondingly solid plastics material—for example, polyimide (PI) or PA66 in conjunction with glass fibers. The encapsulation can be produced, for example, by injection molding, the encapsulation being designed as a rectangular or round housing. Preferably, the encapsulation is substantially in the shape of a circular disk comprising a projection at the exit region of the round cable. Since the edge of the encapsulation pointing towards the flat ribbon cable has a rounding, a straight bending edge can be avoided.

The cable, in particular round cable, has a connecting element, in particular a socket or plug, on its end facing away from the encapsulation. In addition to an electrically-conductive conductor (referred to as inner conductor or also as inner core, strand, or core), the cable can comprise an insulating, preferably polymeric, cable sheath, the insulating cable sheath preferably being removed in each case in the end region of the cable in order to enable an electrically-conductive connection between the conductor of the (round) cable and the flat ribbon cable or the connecting element. The electrically-conductive conductor of the round cable can contain, for example, copper, aluminum, and/or silver, or alloys or mixtures thereof. The round cable has a preferably round or oval cross section, which is, for example, 0.3 mm² to 6 mm².

The invention further relates to a substrate having a functional element comprising the electrical line connection according to the invention.

The invention further relates to a composite pane comprising the substrate according to the invention. The substrate is designed as a first pane, the composite pane having a second pane and two intermediate layers between the first pane and the second pane. The functional element is arranged between the two intermediate layers, the flat ribbon cable being electrically-conductively connected at one end to a surface electrode of the functional element.

The composite pane comprises a first pane and a second pane, which are preferably made of glass, and particularly preferably of soda lime glass, as is customary for window panes. However, the panes can also be manufactured from other types of glass, e.g., quartz glass, borosilicate glass, or aluminosilicate glass, or from rigid clear plastics—for example, polycarbonate or polymethyl methacrylate. The panes can be clear or tinted or colored. If the composite pane is used as a windshield, it should have sufficient light transmission in the central viewing area—preferably at least 70% in the main viewing area A according to ECE-R43. The first pane and the second pane can also be referred to as outer and inner pane.

The first pane, the second pane, and/or the intermediate layer can have further suitable coatings known per se—for example, anti-reflective coatings, non-stick coatings, anti-scratch coatings, photocatalytic coatings or sun protection coatings, or low-e coatings.

The thickness of the first pane and the second pane can vary widely and thus be adapted to the requirements in the individual case. The first pane and the second pane advantageously have standard thicknesses of 0.7 mm to 25 mm—preferably 1.4 mm to 2.5 mm for vehicle glass and preferably 4 mm to 25 mm for furniture, devices, and buildings—in particular, for electric heating elements. The size of the panes can vary widely and depends upon the size of the use according to the invention. For example, the first and the second panes have conventional surfaces of 200 cm² to up to 20 m², as is customary in the vehicle construction and architectural sectors.

The functional element has electrically-controllable optical properties and comprises a first carrier film, a first surface electrode, an active layer, a second surface electrode, and a second carrier film which are arranged one above the other. According to one embodiment of the composite pane according to the invention, the functional element is what is known as a polymer dispersed liquid crystal (PDLC) functional element.

The active layer has the variable optical properties which can be controlled by an electrical voltage applied to the active layer. In the context of the invention, electrically-controllable optical properties are understood to mean properties which are continuously controllable, but also those which can be switched between two or more discrete states. The optical properties relate in particular to light transmission and/or scattering behavior.

The first and second carrier films are in particular polymeric or thermoplastic films. The carrier films contain or consist, in particular, of a thermoplastic material. The thermoplastic material may be a thermoplastic polymer or a mixture of two or more thermoplastic polymers. In addition to the thermoplastic material, the carrier film can also contain additives, such as plasticizers, for example. The thermoplastic material of the carrier films is preferably polyethylene terephthalate (PET), as is customary in commercially available functional elements.

The thermoplastic material of the carrier film can also contain or consist of mixtures of PET with other thermoplastic polymers and/or copolymers of PET. The thermoplastic material of the carrier film can also contain or consist of PU, polypropylene, polycarbonate, polymethyl methacrylate, polyacrylate, polyvinyl chloride, polyacetate resin, fluorinated ethylene propylene, polyvinyl fluoride, and/or ethylene tetrafluoroethylene, for example. The thickness of each carrier film is preferably in the range of 0.03 mm to 0.4 mm, and more preferably of 0.04 mm to 0.2 mm.

The surface electrodes of the functional element comprise an electrically-conductive coating on the carrier film. The side of the carrier film having the electrically-conductive coating that forms the service electrode is then facing the active layer.

In a further advantageous embodiment, the functional element can be divided into segments by insulation lines. The insulation lines are in particular introduced into the surface electrodes, so that the segments of the surface electrode are electrically insulated from one another. The individual segments can be connected independently of one another to an external voltage source via a connection region and the flat conductor, so that, in the operating state, they can be controlled separately. A segment of the functional element then has two connection regions. Each connection region has a contact. Thus, for example, various regions of the functional element can be switched independently—for example, as a sun screen.

In a further preferred embodiment, the functional element is a PNLC or SPD functional element. In the case of an SPD functional element, the active layer contains suspended particles, the absorption of light through the active layer being variable by applying a voltage to the surface electrodes. Polymer network liquid crystal (PNLC) functional elements contain an active layer, in which the liquid crystals are embedded in a polymer network, the mode of operation otherwise being analogous to that of PDLC functional elements.

The surface electrodes are intended to be electrically connected to an external voltage source. Contacting of the surface electrode is preferably carried out by (ultrasonic) soldering, crimping, or adhesive bonding. For this purpose, a conductive material—in particular, a paste—or a solder contact is applied to at least one of the surface electrodes. The paste contains silver or a silver-containing alloy. The conductive material is connected to the surface electrodes as what are known as busbars—for example, strips of the electrically-conductive material or electrically-conductive imprints. The surface electrodes can be electrically contacted by means of one busbar in each case.

In an alternative embodiment of the busbars, thin and narrow metal foil strips or metal wires are used, which preferably contain copper and/or aluminum; in particular, copper foil strips having a thickness of approximately 50 μm are used. The width of the copper foil strips is preferably 1 mm to 10 mm. When the functional element is further processed, the metal foil strips or metal wires are applied to the surface electrode in a composite of thermoplastic layers. In the later autoclave process, a secure electrical contact between the busbars and the coating is achieved by the action of heat and pressure. Alternatively, the electrical contact between the surface electrode and the busbar can be produced by soldering or gluing with an electrically-conductive adhesive.

The busbars are attached to the surface electrodes in that the carrier film, a surface electrode, and the active layer are recessed so that the respective other surface electrode with the associated carrier film protrudes. This can preferably be carried out along an edge region of the respective side of the functional element. A busbar can then be attached on the protruding surface electrode, or the flat ribbon cable can be contacted directly with the surface electrode. A further busbar is attached to the other surface electrode in a corresponding manner on the opposite side of the respective functional element.

In an advantageous embodiment, the functional element is a PDLC functional element, and in particular one that switches at least one region of a glazing unit from a transparent into an opaque state, and vice versa. The active layer of a PDLC functional element contains liquid crystals which are embedded in a polymer matrix. The thickness of the functional element is, for example, from 0.09 mm to 1 mm.

The invention further relates to a vehicle having the electrical line connection according to the invention.

The invention further relates to a method for producing the electrical line connection according to the invention having a cross-sectional transition region, wherein the encapsulation is produced by injection molding. In a first embodiment of the method according to the invention, a plastics material in molten form is brought, in a liquid state, in particular thick-liquid state, within a mold around the cross-sectional transition region. It is then connected to the flat ribbon cable and round cable, and cured, in the mold, by the action of temperature and pressure. As a result, the connection between the round cable and the flat ribbon cable becomes watertight and is, at the same time, insulated.

Furthermore, the invention relates to the use of the electrical line connection according to the invention in a vehicle—in particular, a motor vehicle—for traffic on land, in the air, or on water.

In the following, the invention is explained in more detail with reference to figures and embodiments. The figures are schematic representations and not true-to-scale. The figures do not limit the invention in any way.

In the drawings:

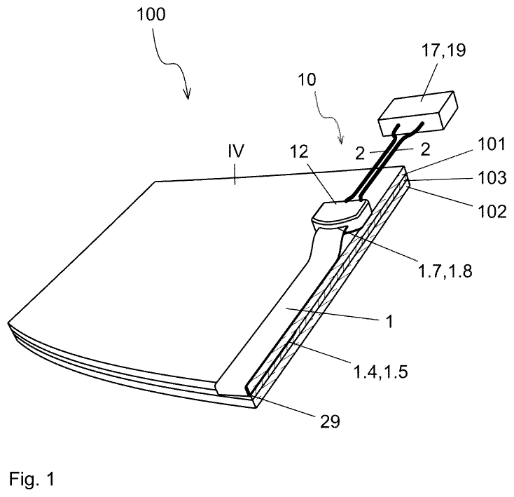

FIG. 1 is a schematic plan view of a composite pane having a line connection according to the invention,

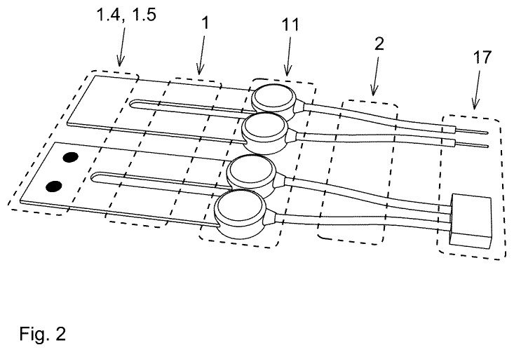

FIG. 2 is a plan view of an embodiment of the line connection according to the invention,

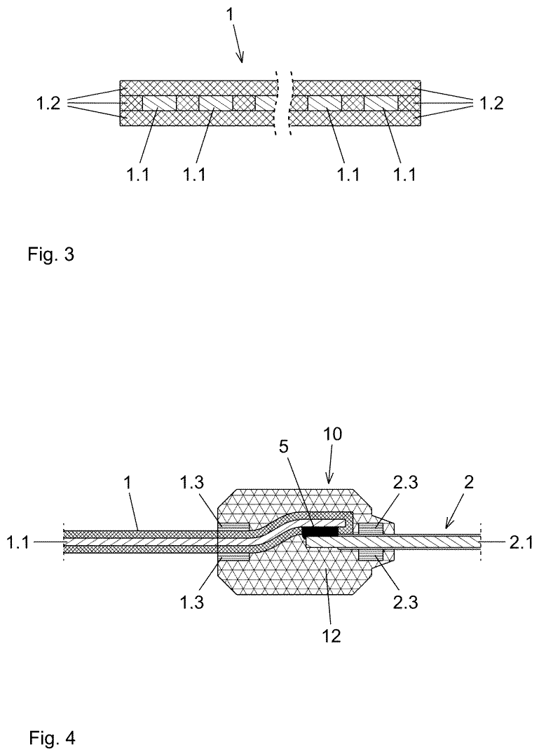

FIG. 3 is a schematic cross section of a flat ribbon cable,

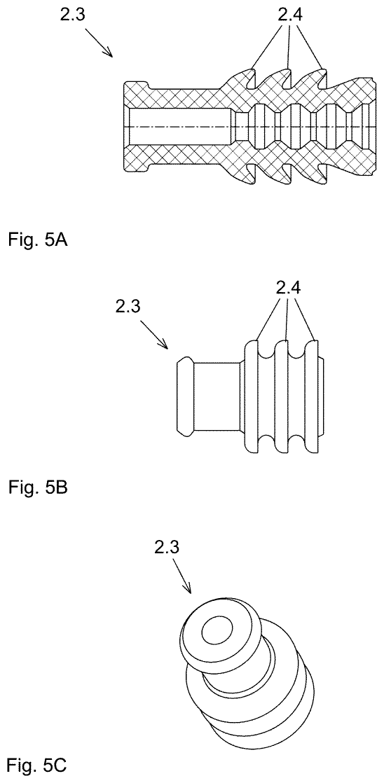

FIG. 4 is a cross section of the line connection according to the invention comprising a first sealing means and a second sealing means,

FIGS. 5A to 5C show an embodiment of the second sealing means, and

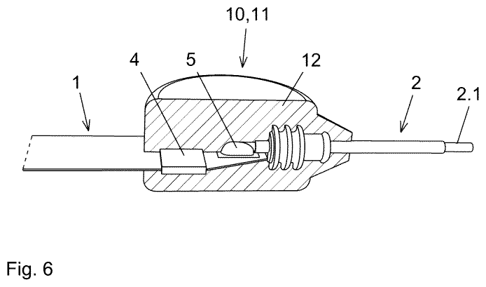

FIG. 6 is a schematic side view of the line connection according to the invention.

The invention will be illustrated in more detail below with reference to the drawings. It should be noted that different aspects are described, each of which can be used individually or in combination. In other words, any aspect may be used with different embodiments of the invention unless explicitly shown as a pure alternative.

Data with numerical values are generally not to be understood as exact values, but also include a tolerance of +/−1% up to +/−10%.

FIG. 1 shows a composite pane 100 and a substrate 101 comprising a line connection 10 according to the invention. The composite pane 100 and the substrate 101 are designed, for example, as glazing units. In this case, the composite pane 100 is designed as a roof panel of a motor vehicle.

The composite pane 100 comprises the substrate as a first pane 101, as well as a second pane 102. In the installed position, the first pane 101 serves as an inner pane and the second pane 102 as an outer pane. In this case, the inner pane is the pane facing the interior of the vehicle, while the outer pane faces the surroundings of the vehicle. The surface of the outer pane (second pane 102) facing the surroundings of the vehicle is referred to as surface I, as is customary in vehicle glazing technology, and the surface of the inner pane (first pane 101) facing the interior of the vehicle is referred to as surface IV. The two panes 101 and 102 consist, for example, of soda lime glass. The two panes 101 and 102 are firmly bonded to one another by two, thermoplastic, intermediate layers 103—for example, made of polyvinyl butyral (PVB), ethylene vinyl acetate (EVA), or polyurethane (PU).

The composite pane 100 is also provided with an electrical functional element located between the two panes 101 and 102. The electrical functional element can, for example, be a PDLC functional element which serves, for example, as an electrically-controllable sun screen or privacy shield. The PDLC functional element is formed by a commercially available PDLC multilayer film which is embedded in the intermediate layer 103. For this purpose, the intermediate layer 103 comprises, for example, a total of three thermoplastic films (not shown) having a thickness of, for example, 0.38 mm, and made of PVB, a first thermoplastic film being connected to the first pane 101, and a second thermoplastic film being connected to the second pane 102, and a thermoplastic frame film therebetween having a cutout into which the cut-to-size functional element is inserted with an accurate fit. The third thermoplastic film thus forms a type of mount, as it were, for the functional element, which is thus encapsulated all around by thermoplastic material and protected thereby. The PDLC functional element generally comprises an active layer between two surface electrodes and two carrier films. The active layer contains a polymer matrix having liquid crystals dispersed therein, which align themselves depending on the electrical voltage applied to the surface electrodes, whereby the optical properties can be controlled. The surface electrodes can be electrically contacted via busbars. Electrical line connections are required for applying a voltage to the busbars.

The composite pane 100 further has a flat ribbon cable 1. The busbars of the functional element are electrically-conductively connected to the flat ribbon cable 1. A secure, electrically-conductive connection is preferably achieved by soldering the connection.

The functional element is a PDLC functional element that functions as a controllable sunshade or privacy screen. Depending upon the position of the sun, the driver or another vehicle occupant can operate the PDLC functional element via a touch control, for example.

It is understood that the flat ribbon cable 1 can be adapted to the respective conditions of the actual use and can extend, for example, over two, three, or four planes. Alternatively or in combination, more or fewer conductor tracks can be arranged next to each other per plane.

As illustrated in the schematic insertion of FIG. 1, the flat ribbon cable 1 is laminated in part into the composite pane 100, by its first end 1.4, and is guided out of the composite pane 2 between the two panes 101, 102.

In FIG. 1, the flat ribbon cable 1 is routed around the side surface of the first pane 101 and is arranged on the surface IV of the first pane 101. For this purpose, the first pane 101 can have a recess in the exit region 29—for example, in form of a sanded region (not shown here).

The flat ribbon cable 1 has a first connection region 1.5 and a second connection region 1.8, the first connection region 1.5 being located at a first end 1.4, and the second connection region 1.8 being located at a second end 1.7, of the flat ribbon cable 1, along a direction of extension of the flat ribbon cable 1. In the first connection region 1.5, the flat ribbon cable 1 has at least one connection electrode for electrical (e.g., galvanic) contacting of the functional element. The second connection region 1.8 is located inside an encapsulation 12, into which at least one end of a cable, in particular a (round) cable 2, is inserted.

The line connection 10 according to the invention having the cross-sectional transition region 11 can be produced easily and cost-effectively and allows space-saving, flexibly usable, and permanently stable electrical contacting of a functional element arranged in a composite pane 100.

FIG. 2 is a plan view of a further embodiment of the line connection 10 according to the invention. Four parallel line connections 10 are shown. Each electrical line connection 10 comprises a flat ribbon cable 1, which has a conductor track 1.1 and a cover film 1.2 for insulating the conductor track 1.1.

At its two ends 1.4 and 1.7 that are opposite in the extension direction, each flat ribbon cable 1 has a first connection region 1.5 and a second connection region 1.8. The connection regions 1.5 and 1.8 of the flat ribbon cable 1 serve for electrically contacting the conductor tracks 1.1. The second connection region 1.8 is located inside the encapsulation 12, into which one end of the round cable 2 is inserted.

The encapsulation 12 consists, for example, of a solid plastics material, for example polyamide (PA) and/or polyimide (PI), PBT, PA611, PA12, PA6, or PA66 in conjunction with glass fibers (up to 50%). The encapsulation 12 serves to insulate the electrical contacting (for example soldering) between the flat ribbon cable 1 and the round cable 2. The encapsulation 12 can be produced, for example, by injection molding or 3D printing.

The cover film 1.2 is removed at least in part at the contact points so that the conductor tracks 1.1 are accessible. The cover film 1.2 has a recess. This can be achieved, for example, by a window technique during production or by subsequent removal of the cover film 1.2, for example by laser ablation.

The cross-sectional transition region 11 comprises an electrical connection between the conductor track 1.1 of the flat ribbon cable 1 and the conductor 2.1 of the round cable 2. The cross-sectional transition region 11 comprises the encapsulation 12.

In addition to an electrically-conductive conductor 2.1, the round cable 2 also comprises an insulating, polymeric cable sheath 2.2, the insulating cable sheath being removed in the end region of the cable in order to enable an electrically-conductive connection between the conductor 2.1 of the cable 2 and the conductor track 1.1. The electrically-conductive conductor 2.1 of the cable 2 contains copper. The cable 2 has a round or oval cross section, the cross-sectional area of which is, for example, 5 mm².

The round cable 2 can, in principle, be any connection cable known to the person skilled in the art for electrical contact of a functional element and is suitable for being connected to a connecting element (also called crimp contact) by crimping or clamping. The conductor 2.1 (also referred to as the inner core or core) of the round cable 2 is stripped at its end facing the flat ribbon cable 1 and is rigidly connected to the conductor track 1.1 via a solder connection 5. A connection element, e.g., a plug or a socket 17, for example, can be arranged on the end of the round cable 2 facing away from the flat ribbon cable 1, for further electrical connection, for example to an on-board electronics system.

FIG. 3 is a schematic cross-sectional view of an embodiment of the flat ribbon cable 1. The conductor tracks 1.1 are uniformly spaced apart from one another and each have a rectangular cross section. The conductor tracks 1.1 are surrounded by an insulation sheath consisting of the cover film 1.2. For this purpose, the cover film 1.2 is glued to the conductor track 1.1.

The flat ribbon cable 1 can comprise several conductor tracks 1.1. The conductor tracks 1.1 are then arranged next to one another and/or lying one above the other. The electrical conductor tracks 1.1 consist, for example, of a thin copper, silver, tin, or gold film. The films can additionally be plated for example, silver-plated, gold-plated, or tin-plated. The thickness of the films is, for example, 35 μm, 50 μm, 75 μm, or 100 μm.

A film made of polyimide, preferably black or yellow polyimide films (e.g., PI-MTB/MBC), e.g., having a thickness of 25 μm, are particularly suitable for the material of the cover film 1.2. Alternatively, polymer films of PEN—preferably of white PEN, e.g., with a thickness of 25 μm—can be used.

Adhesive layers between the first cover film 1.2 and the electrical conductor track 1.1 can contain or consist of epoxy adhesives or thermoplastic adhesives, for example. Typical thicknesses of the adhesive films are from 25 μm to 35 μm. The adhesives can be transparent or colored—for example, black.

FIG. 4 shows an embodiment of the line connection 10 according to the invention comprising a first sealing means 1.3 and a second sealing means 2.3. The electrical line connection 10 according to the invention comprises a cross-sectional transition region 11 from the flat ribbon cable 1 according to the invention to a round cable 2 comprising at least one electrical conductor 2.1. The flat ribbon cable 1 comprises the conductor track 1.1 and the cover film 1.2. The cover film 1.2 has a recess so that the conductor track 1.1 can be contacted with the conductor 2.1 of the round cable 2.

The cross-sectional transition region 11 comprises an electrical connection between the conductor track 1.1 of the flat ribbon cable 1 and the conductor 2.1 of the round cable 2. The cross-sectional transition region 11 comprises the encapsulation 12. The encapsulation 12 has a circular cross section having a projection at the exit region of the round cable 2.

The first sealing means 1.3 is provided on the flat ribbon cable 1, and the second sealing means 2.3 is provided on the round cable 2. When the encapsulation 12 is attached to the line connection 10, the first sealing means 1.3 is pressed firmly against the flat ribbon cable 1 and the second sealing means 2.3 is pressed firmly against the round cable 2 so that a seal is produced around the respective cable. Such an arrangement of the sealing means 1.3 and 2.3 (seals) ensures that the penetration of water into the encapsulation 12, by a capillary effect, is prevented.

The first sealing means 1.3 is a double-sided adhesive tape which is arranged on two opposite surfaces of the flat ribbon cable 1. The first sealing means 1.3 is mounted around the flat ribbon cable 1. The adhesion by the adhesive tape advantageously supports the adhesion of the encapsulation 12 to the flat ribbon cable 1 so that the connection between the encapsulation 12 and the flat ribbon cable 1 is very tight and stable. In particular, the adhesive tape may be an acrylic adhesive tape. In addition, the adhesive tape may be transparent. The material thickness of the adhesive tape can have a thickness of 25 μm to 2 mm, preferably 100 μm to 150 μm, particularly preferably 130 μm.

The encapsulation 12 can cover the first sealing means 1.3 and the second sealing means 2.4 completely or only in part.

In addition to an electrically-conductive conductor 2.1, the round cable 2 also comprises an insulating, polymeric cable sheath, the insulating cable sheath being removed in the end region of the cable in order to enable an electrically-conductive connection between the conductor 2.1 of the round cable 2 and the conductor track 1.1. The electrically-conductive conductor 2.1 of the round cable 2 contains copper. The round cable 2 has a round cross section, the cross-sectional area of which is, for example, 5 mm².

FIG. 5A to 5C show an embodiment of the second sealing means 2.3. The second sealing means 2.3 has a ring shape. In this case, the second sealing means 2.3 surrounds the round cable 2 in a flush manner, i.e., the second sealing means 2.3 is arranged all around the round cable 2 (FIG. 4). The second sealing means 2.3 can be fastened to and molded onto the round cable 2 during production. The second sealing means 2.3 can be mounted on the round cable before the encapsulation 12 is produced. As shown in FIG. 4, the second sealing means 2.3 is formed as a collar portion on the round cable 2.

The second sealing means 2.3 shown in FIG. 5A has three sealing lips 2.4. Alternatively, the second sealing means 2.3 can have one, two, or four sealing lips 2.4. The circumferential sealing lips 2.4 act on a radially outwardly facing portion of the second sealing means 2.3. A higher water resistance of the electrical line connection can be achieved by the three sealing lips 2.4. In addition, the second sealing means 2.3 can have an undulating surface, in portions, on its surface facing the round cable 2. As shown in FIG. 5B, the three sealing lips 2.4 are arranged one behind the other in the direction of extension of the round cable 2 and are at a distance from one another. The three sealing lips 2.4 have outer edges extending in parallel with one another. FIG. 5C is a perspective plan view of the second sealing means 2.3. The second sealing means may contain silicone, polyvinyl chloride or thermoplastic elastomers.

FIG. 6 shows the line connection 10 according to the invention with a cross section through the encapsulation 12. The encapsulation 12 is produced by means of injection molding. The encapsulation 12 is substantially in the shape of a circular disk comprising a projection at the exit region of the round cable 2. This shape of the encapsulation 12 surrounds the first sealing means 1.3 and the second sealing means 2.3 so that a high-density and resistant connection is produced. The first sealing means 1.3 and the second sealing means 2.3 cause the electrical line connection 10, in particular the encapsulation region, to be sealed and watertight.

### LIST OF REFERENCE SIGNS

1 Flat ribbon cable
1.1 Conductor track
1.2 Cover film
1.3 First sealing means
1.4 First end
1.5 First connection region
1.6 First partial region of the flat cable
1.7 Second end
1.8 Second connection region
2 Round cable
2.1 Conductor of the cable
2.3 Second sealing means
2.4 Sealing lip
4 Adhesive tape
5 Solder connection
10 Line connection
11 Cross-sectional transition region
12 Encapsulation
17 Socket or plug
19 Protective housing
29 Exit point
100 Laminated glass pane
101 First pane (substrate)
102 Second pane
103 Intermediate layer
I Second surface (outer side) of the second pane 102
IV First surface (inner side) of the first pane 101

1. An electrical line connection having a cross-sectional transition region from a flat ribbon cable to a cable,
wherein the flat ribbon cable comprises at least one electrical conductor track and a cover film for electrically insulating the conductor track,
wherein the cable comprises at least one electrical conductor,
wherein, in the cross-sectional transition region, an electrical connection between the conductor track of the flat ribbon cable and the conductor of the cable is provided,
wherein the cross-sectional transition region has an encapsulation for electrical insulation, and
wherein a first sealing means is provided on the flat ribbon cable and a second sealing means is provided on the cable,
wherein the first sealing means is a double-sided adhesive tape which is arranged on two opposite surfaces of the flat ribbon cable and wherein the second sealing means has one or more sealing lips.

2. The electrical line connection according to claim 1, wherein the adhesive tape is an acrylic adhesive tape.

3. The electrical line connection according to claim 1, wherein the adhesive tape is transparent.

4. The electrical line connection according to claim 1, wherein the first sealing means and the second sealing means are covered by the encapsulation.

5. The electrical line connection according to claim 1, wherein the second sealing means has a ring shape.

6. The electrical line connection according to claim 1, wherein the second sealing means contains silicone, polyvinyl chloride or thermoplastic elastomers.

7. The electrical line connection according to claim 1, wherein the second sealing means is formed as a collar portion on the cable.

8. The electrical line connection according to claim 1, wherein the conductor track of the flat ribbon cable is electrically-conductively connected to the conductor of the cable via a solder connection.

9. The electrical line connection according to claim 1, wherein the encapsulation has a plastics material as the insulating material.

10. The electrical line connection according to claim 1, wherein the encapsulation has the shape of a circular disk with a projection at the exit region of the round cable.

11. A substrate having a functional element comprising an electrical line connection according to claim 1.

12. A composite pane comprising the substrate according to claim 11.

13. The composite pane according to claim 12, wherein the substrate is formed as a first pane, and the composite pane has a second pane and two intermediate layers between the first pane and the second pane, wherein a functional element is arranged between the two intermediate layers, and the flat ribbon cable is electrically-conductively connected, at the first end, to a surface electrode of the functional element, and is provided for connection to a supply voltage of a vehicle by means of the second end via the round cable.

14. A vehicle comprising an electrical line connection according to claim 1.

15. The electrical line connection according to claim 1, wherein the cable is a round cable.
